(19) United States
(12) Patent Application Publication
(10) Pub. No.: US 2013/0193386 A1
(43) Pub. Date: Aug. 1, 2013

(54) THERMOCHROMIC SYSTEMS WITH CONTROLLED HYSTERESIS

(71) Applicant: Timothy Owen, Colorado Springs, CO (US)

(72) Inventor: Timothy Owen, Colorado Springs, CO (US)

(21) Appl. No.: 13/363,070

(22) Filed: Jan. 31, 2012

(51) Int. Cl. C09D 11/02; C09D 7/12

(52) U.S. Cl. 252/583

(57) ABSTRACT

The present disclosure is a method for controlling the hysteresis window and improving the color switching properties of reversible thermochromic dye systems. The method adds preferred co-solvents to existing reversible thermochromic dye systems in order to decrease the temperature range between the full color point and the clearing point. The co-solvents also add resistance to ultraviolet radiation.

### FIELD

This disclosure pertains to the field of thermochromic dye systems. More particularly, these are reversible thermochromic dye systems having a controllable color transition range across a hysteresis window of the system.

### BACKGROUND

Dyes that change color over a range of temperatures are known as thermochromic dyes. Thermochromic dyes can be manufactured to have a color change that is reversible or irreversible. Formulated as inks or dyes, they are used in a variety of applications such as plastic masterbatch, paper, textiles, coatings, offset ink, metal decorating inks and coatings, ultraviolet radiation curable inks and coatings, solvent based inks and coatings, screen inks and coatings, gravure inks and coatings, paints, security printing, brand protection, smart packaging, marketing and novelty printing, among other uses.

Thermochromic dyes use colorants that are either liquid crystals or leuco dyes. Liquid crystals are used less frequently than leuco dyes because they are very difficult to work with and require highly specialized printing and handling techniques.

Thermochromic dyes are a system of interacting parts. The parts of the system are leuco dyes acting as colorants, weak organic acids acting as color developers and solvents that variably interact with components of the system according to the temperature of the system. Thermochromic dye systems are microencapsulated in a protective coating to protect the contents from undesired effects from the environment. Each microcapsule is self-contained, having all of the components of the entire system required to reproduce the color change. The components of the system interact with one another differently at different temperatures. Generally, the system is ordered and colored below a temperature corresponding to the full color point. The system becomes increasingly unordered and starts to lose its color at a temperature corresponding to a predetermined activation temperature.

Below the activation temperature, the system is colored and above the activation temperature they are clear or lightly colored. The activation temperature corresponds to a range of temperatures at which the transition is taking place between the full color point and the clearing point. Generally, the activation temperature is defined as the temperature at which the human eye can perceive that the system is starting to lose color, or alternatively, starting to gain color. Presently, thermochromic systems are designed to have activation temperatures over a broad range, from about −20° C. to about 80° C. or more. With heating, the system becomes increasingly unordered and continues to lose its color until it reaches a level of disorder at a temperature corresponding to a clearing point. At the clearing point, the system lacks any recognizable color.

Specific thermochromic ink formulations are known in the art. See, for example, U.S. Pat. Nos. 4,720,301, 5,219,625 5,558,700, 5,591,255, 5,997,849, 6,139,779, 6,494,950 and 7,494,537, all of which are expressly incorporated herein by reference to the same extent as though fully replicated herein. These thermochromic inks are known to use various components in their formulations, and are generally reversible in their color change. Thermochromic inks are available in various colors, with various activation temperatures, clearing points and full color points. Thermochromic inks may be printed by offset litho, dry offset, letterpress, gravure, flexo and screen processes, amongst others. Thermochromic inks containing leuco dyes are available for all major ink types such as water-based, ultraviolet cured and epoxy. The properties of these inks differ from process inks. For example, most thermochromic inks contain the thermochromic systems as microcapsules, which are not inert and insoluble as are ordinary process pigments. The size of the microcapsules containing the thermochromic systems ranges typically between 3-5 μm which is more than 10-times larger than regular pigment particles found in most inks. The post-print functionality of thermochromic inks can be adversely affected by ultraviolet light, temperatures in excess of 140° C. and aggressive solvents. The lifetime of these inks is sometimes very limited because of the degradation caused by exposure to ultraviolet light from sunshine. Thus, there is a need in the art for thermochromic systems in inks and coatings having resistance to degradation from exposure to ultraviolet light.

Temperature changes in thermochromic systems are associated with color changes. If this change is plotted on a graph having axes of temperature and color, the curves do not align and are offset between the heating cycle and the cooling cycle. The entire color versus temperature curve has the form of a loop. See generally FIG. 1A where the extent of color change presents a gap 100a that differs between color change that occurs upon heating 102 versus cooing 103. FIG. 1B presents a relatively larger gap 100b. Such a result shows that the color of a thermochromic system does not depend only on temperature, but also on the thermal history, i.e. whether the particular color was reached during heating or during cooling. This phenomenon is generally referred to as a hysteresis cycle and specifically referred to herein as color hysteresis or the hysteresis window. Decreasing the width of this hysteresis window to approximately zero would allow for a single value for the full color point and a single value for the clearing point. This would allow for a reliable color transition to be observed regardless of whether the system is being heated or cooled. Nonetheless, the concept decreasing separation across the hysteresis window is elusive in practice. The extent of the respective gaps 100a, 100b may be controlled according to the instrumentalities described herein.

Prior art reveals that the color transition range of microencapsulated thermochromic systems may be adjusted by shifting the full color point upward toward the clearing point, or shifting the clearing point downward toward the full color point, as explained in U.S. Pat. No. 6,494,950. These shifts are accomplished by adding high melting point materials to increase the full color point or, alternatively, by adding low melting point materials to the system to decrease the clearing point. Thus, the full color point or clearing point may be lowered or raised, but the overall temperature range between the two points remains unchanged because the amount of separation or width across the hysteresis window is left largely unaffected.

### SUMMARY

Thermochromic inks having a reduced susceptibility to UV degradation and/or a reduced hysteresis window in the sense of a narrowed color transition range from the full color point to the clearing point in comparison to existing thermochromic systems are described herein. The thermochromic inks with a controlled color transition range advantageously allow for new applications of thermochromic inks in products that require a display of color at a precise temperature. Alternatively, inks and coatings with wide hysteresis for new applications provide unique properties that may be utilized for particular applications from user interactivity to semi-irreversible behavior.

Thermochromic inks contain microcapsules, which encapsulate a thermochromic system mixed with a solvent. The thermochromic system has a material property of a thermally conditional hysteresis window that presents a thermal separation. These inks may be altered according to the instrumentalities described herein by using a co-solvent that is combined with the thermochromic system and selected from the group consisting of derivatives of myristic acid, derivatives of behenyl acid, derivatives of palmytic acid and combinations thereof. By way of example, this material may be provided in an effective amount to reduce the thermal separation in the overall ink to a level less than eighty percent of separation that would otherwise occur if the material were not added. This effective amount may range, for example from the 12% to 15% by weight of the composition.

Especially preferred co-solvents include isopropyl myristate, isopropyl palmitate, methyl palmitate, methyl stearate, myristyl, myristate, cetyl alcohol, stearyl alcohol, behenyl alcohol, stearyl behenate, and stearamide. These co-solvents may be combined in any manner or proportion to achieve the effective amount.

The thermochromic system may contain, for example, at least one chromatic organic compound selected from the group consisting of diphenylmethane phthalide derivatives, phenylindolylphthalide derivatives, indolylphthalide derivatives, diphenylmethane azaphthalide derivatives, phenylindolylazaphthalide derivatives, fluoran derivatives, styrynoquinoline derivatives, and diaza-rhodamine lactone derivatives. Light stabilizers may also be added to protect against the deleterious effects of ultraviolet radiation.

Within the encapsulated thermochromic systems, complexes form between the dye and the weak acid developer that allow the lactone ring structure of the leuco dye to be opened. The nature of the complex is such that the hydroxyl groups of the phenolic developer interact with the lactone ring structure forming a supra-molecular structure that orders the dyes and developers such that a color is formed. Color forms from this supra-molecular structure because the dye molecule in the ring open structure is cationic in nature and the molecule has extended its conjugation allowing absorption in the visible spectrum thus producing a colored species. The color that is perceived by the eye is what visible light is not absorbed by the complex. The extent of the dye/developer complex depends on the molar ratio of dye and developer. The stability of the colored complex is determined by numerous factors including the affinity of the solvent for itself, the developer or the dye/developer complex. In a solid state, below the full color point, the dye/developer complex is stable. In the molten state, the solvent destabilizes the dye/developer complex and the equilibrium is more favorably shifted towards a developer/solvent complex. This happens at temperatures above the full color point because the dye/developer complex is disrupted and the extended conjugation of the π cloud electrons that allow for the absorption of visible light is reversibly broken.

The melting and crystallization profile of the solvent system determines the nature of the thermochromic system. The full color point of the system occurs when the maximum amount of dye is developed. In a crystallized solvent state, the dye/developer complex is favored where the dye and developer exist in a unique crystallized structure, often intercalating with one another to create an extended conjugated π system. In the molten state, the solvent(s), in excess, have enough kinetic energy to disrupt the stability of the dye/developer complex, and the thermochromic system becomes decolorized.

The addition of a co-solvent with a significantly higher melting point than the other dramatically changes the melting properties of both the solvents. By mixing two solvents that have certain properties, a blend can be achieved that possesses a eutectic melting point. The melting point of a eutectic blend is lower than the melting point of either of the co-solvents alone and the melting point is sharper, occurring over a smaller range of temperatures. The degree of the destabilization of the dye/developer complex can be determined by the choice of solvents. By creating unique eutectic blends, both the clearing point and the full color point can be altered simultaneously. The degree of hysteresis is then shifted in both directions simultaneously as the sharpness of the melting point is increased.

Preferred properties of at least one of the co-solvents used in the present disclosure include having a long fatty tail of between 12 and 24 carbons and possessing a melting point that is about 70° C. to about 200° C. greater than the co-solvent partner. The co-solvents are preferably also completely miscible at any ratio.

It is an object of the present disclosure to provide thermochromic systems with a reduced hysteresis window achieved by shifting both the full color point and the clearing point.

It is a further object of this disclosure to provide solvent and co-solvent systems that act as light stabilizers and temperature control regulators that modify the temperature profile of the thermochromic system while at the same time improving the stability of the thermochromic system to exposure to ultraviolet light.

It is also an object of the present disclosure to provide ink formulations and a method of correcting formulations that normally destroy the color changing properties of thermochromic systems possessing narrower color hysteresis windows and narrower color transition temperature ranges when compared to pre-existing thermochromic systems.

### DEFINITIONS

Thermochromic system—A mixture of dyes, developers, solvents, and additives (encapsulated or non-encapsulated) that can undergo reversible or semi-irreversible color change in response to temperature changes.

Full color point—The temperature at which a thermochromic system has achieved maximum color density upon cooling and appears to gain no further color density if cooled to a lower temperature.

Activation temperature—The temperature above which the ink has almost achieved its final clear or light color end point. The color starts to fade at approximately 4° C. below the activation temperature and will be in between colors within the activation temperature range.

Clearing point—The temperature at which the color of a thermochromic system is diminished to a minimal amount and appears to lose no further color density upon further heating.

Hysteresis—The difference in the temperature profile of a thermo chromic system when heated from the system when cooled.

Hysteresis window—The temperature difference in terms of degrees that a thermochromic system is shifted as measured between the derivative plot of chroma of a spectrophotometer reading between the cooling curve and the heating curve.

Leuco dye—A leuco dye is a dye whose molecules can acquire two forms, one of which is colorless.

Eutectic system—A eutectic system is a mixture of at least two solvents having one composition of the at least two solvents having a freezing point at a lower temperature than any other mixture of the solvents.

Eutectic temperature—The temperature at which the eutectic system freezes is known as the eutectic temperature.

### BRIEF DESCRIPTION OF THE DRAWINGS

FIG. 1 shows generally the effect of controlling color hysteresis in a thermochromic system where FIG. 1A has a narrower hysteresis gap than does FIG. 1B;

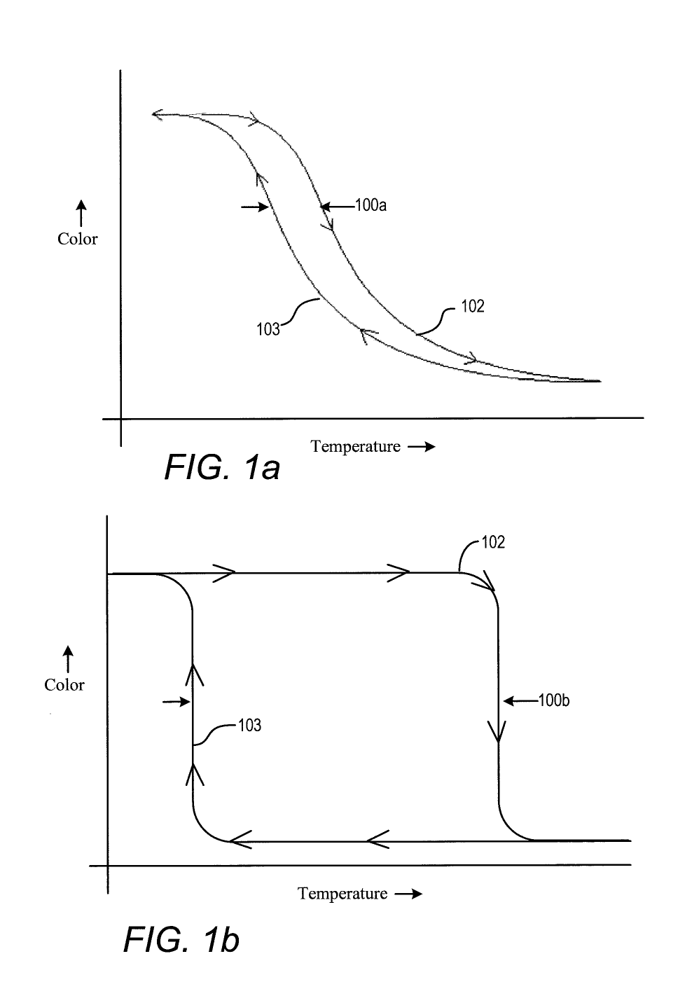

FIG. 2 is a plot of color change versus temperature for a reversible thermochromic dye; and

FIG. 3 is a plot of color change versus temperature for a reversible thermochromic dye.

### DETAILED DESCRIPTION

Thermochromic systems are prepared by combining a color forming molecule or molecules such as leuco dyes that are capable of extended conjugation by proton gain or electron donation; a color developer or developers that donate a proton or accept an electron; and a single solvent, or a blend of co-solvents. The solvent or blend of co-solvents are chosen based on melting point and establish the thermochromic temperature range of the system. These formulations are then microencapsulated within a polymeric shell.

### Leuco Dyes

Leuco dyes most commonly used as color formers in thermochromic systems of the present disclosure include, but are not limited to, generally; spirolactones, fluorans, spiropyrans, and fulgides; and more specifically; diphenylmethane phthalide derivatives, phenylindolylphthalide derivatives, indolylphthalide derivatives, diphenylmethane azaphthalide derivatives, phenylindolylazaphthalide derivatives, fluoran derivatives, styrynoquinoline derivatives, and diaza-rhodamine lactone derivatives which can include: 3,3-bis(p-dimethylaminophenyl)-6-dimethylaminophthalide; 3-(4-diethylaminophenyl)-3-(1-ethyl-2-methylindol-3-yl)phthalide; 3,3-bis(1-n-butyl-2-methylindol-3-yl)phthalide; 3,3-bis(2-ethoxy-4-diethylaminophenyl)-4-azaphthalide; 3-[2-ethoxy-4-(N-ethylanilino)phenyl]-3-(1-ethyl-2-methylindol-3-yl)-4-azaphthalide; 3,6-dimethoxyfluoran; 3,6-di-n-butoxyfluoran; 2-methyl-6-(N-ethyl-N-p-tolylamino)fluoran; 3-chloro-6-cyclohexylaminofluoran; 2-methyl-6-cyclohexylaminofluoran; 2-(2-chloroanilino)-6-di-n-butylamino fluoran; 2-(3-trifluoromethylanilino)-6-diethylaminofluoran; 2-(N-methylanilino)-6-(N-ethyl-N-p-tolylamino)fluoran, 1,3-dimethyl-6-diethylaminofluoran; 2-chloro-3-methyl-6-diethylamino fluoran; 2-anilino-3-methyl-6-diethylaminofluoran; 2-anilino-3-methyl-6-di-n-butylamino fluoran; 2-xylidino-3-methyl-6-diethylaminofluoran; 1,2-benzo-6-diethylaminofluoran; 1,2-benzo-6-(N-ethyl-N-isobutylamino)fluoran, 1,2-benzo-6-(N-ethyl-N-isoamylamino)fluoran; 2-(3-methoxy-4-dodecoxystyryl)quinoline; spiro[5H-(1) benzopyrano(2,3-d)pyrimidine-5,1′(3′H)isobenzofuran]-3′-one; 2-(diethylamino)-8-(diethylamino)-4-methyl-spiro[5H-(1)benzopyrano(2,3-d)pyrimidine-5,1′(3′H)isobenzofuran]-3′-one; 2-(di-n-butylamino)-8-(di-n-butylamino)-4-methyl-spiro[5H-(1)benzopyrano(2,3-d)pyrimidine-5,1′(3′H)isobenzofuran]-3′-one; 2-(di-n-butylamino)-8-(diethylamino)-4-methyl-spiro[5H-(1)benzopyrano(2,3-d)pyrimidine-5,1′(3′H)isobenzofuran]-3′-one; 2-(di-n-butylamino)-8(N-ethyl-N-isoamylamino)-4-methyl-spiro[5H-(1)benzopyrano(2,3-d)pyrimidine-5,1′(3′H)isobenzofuran]-3′-one; and 2-(di-n-butylamino)-8-(di-n-butylamino)-4-phenyl and trisubstituted pyridines.

Particularly preferred materials for use as chromatic organic compounds are of diphenylmethane phthalide derivatives, phenylindolylphthalide derivatives, indolylphthalide derivatives, diphenylmethane azaphthalide derivatives, phenylindolylazaphthalide derivatives, fluoran derivatives, styrynoquinoline derivatives, 2,4,6, trisubstituted pyridines, quinazolines, bis-quinazolines, and diaza-rhodamine lactone derivatives, in any combination.

Specific examples of 2,4,6 trisubstituted pyridine dyes are described in detail in copending U.S. patent application Ser. No. 61/542,738 filed Oct. 3, 2011, which is hereby incorporated by reference to the same extent as though fully replicated herein. Compounds 1-45 below are dyes that exemplify these materials and may be used in any combination.

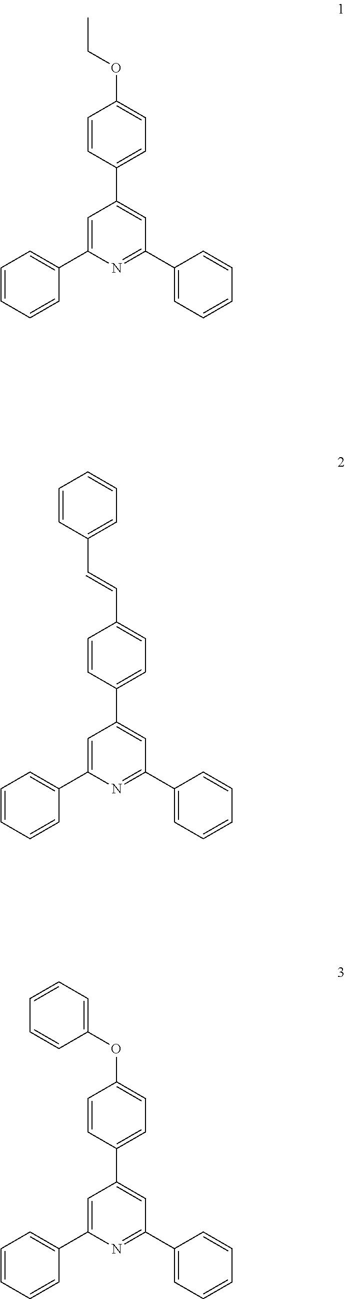 [SMILES: CCOc1ccc(-c2cc(-c3ccccc3)nc(-c3ccccc3)c2)cc1 ; C(=C\c1ccc(-c2cc(-c3ccccc3)nc(-c3ccccc3)c2)cc1)/c1ccccc1 ; c1ccc(Oc2ccc(-c3cc(-c4ccccc4)nc(-c4ccccc4)c3)cc2)cc1]

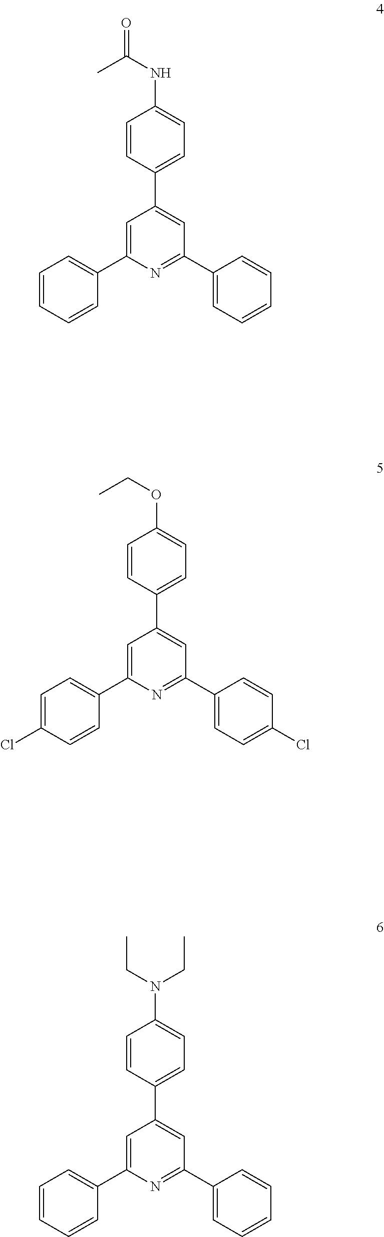 [SMILES: CC(=O)Nc1ccc(-c2cc(-c3ccccc3)nc(-c3ccccc3)c2)cc1 ; CCOc1ccc(-c2cc(-c3ccc(Cl)cc3)nc(-c3ccc(Cl)cc3)c2)cc1 ; CCN(CC)c1ccc(-c2cc(-c3ccccc3)nc(-c3ccccc3)c2)cc1]

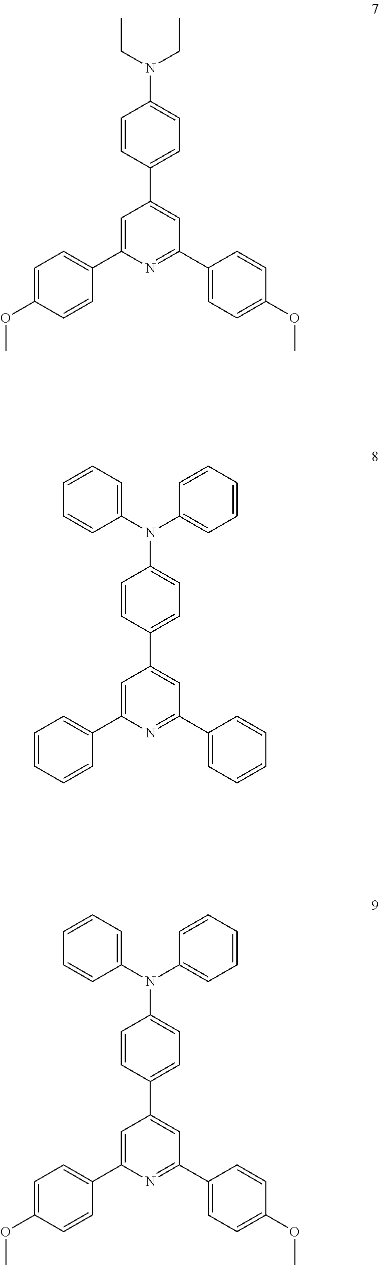 [SMILES: CCN(CC)c1ccc(-c2cc(-c3ccc(OC)cc3)nc(-c3ccc(OC)cc3)c2)cc1 ; c1ccc(-c2cc(-c3ccc(N(c4ccccc4)c4ccccc4)cc3)cc(-c3ccccc3)n2)cc1 ; COc1ccc(-c2cc(-c3ccc(N(c4ccccc4)c4ccccc4)cc3)cc(-c3ccc(OC)cc3)n2)cc1]

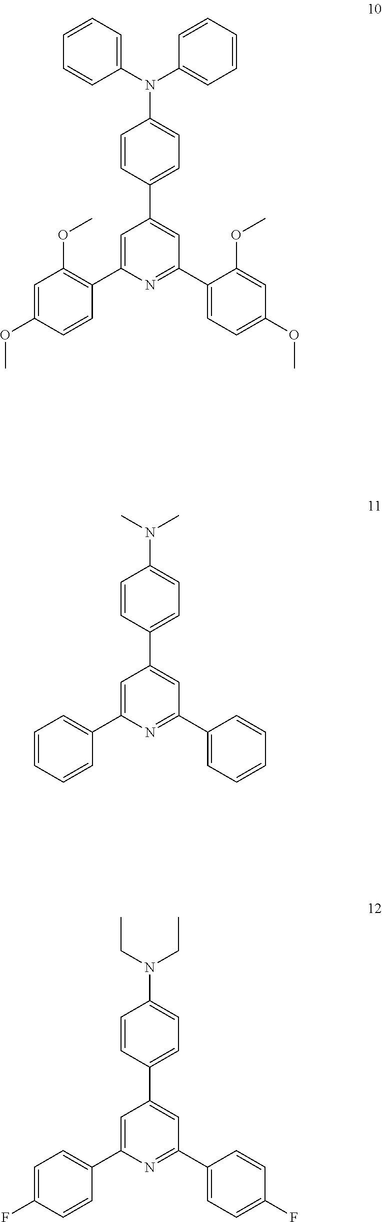 [SMILES: COc1ccc(-c2cc(-c3ccc(N(c4ccccc4)c4ccccc4)cc3)cc(-c3ccc(OC)cc3OC)n2)c(OC)c1 ; CN(C)c1ccc(-c2cc(-c3ccccc3)nc(-c3ccccc3)c2)cc1 ; CCN(CC)c1ccc(-c2cc(-c3ccc(F)cc3)nc(-c3ccc(F)cc3)c2)cc1]

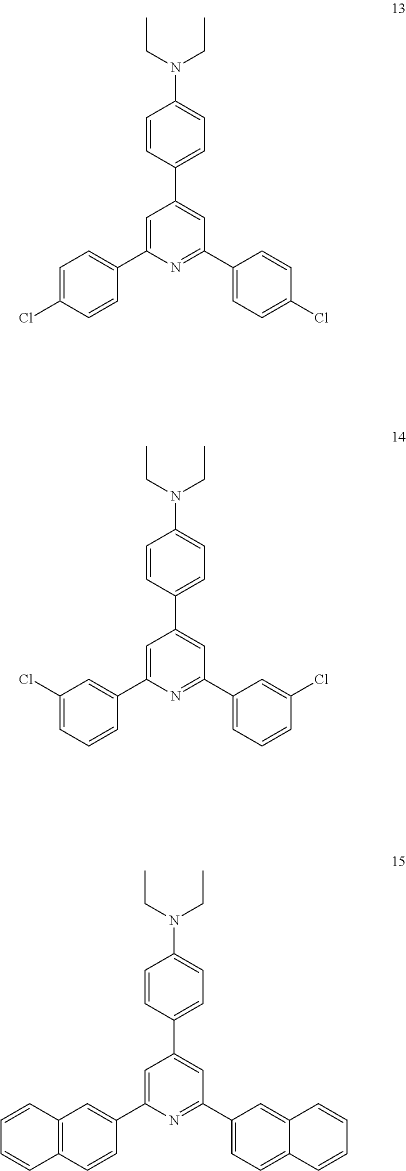 [SMILES: CCN(CC)c1ccc(-c2cc(-c3ccc(Cl)cc3)nc(-c3ccc(Cl)cc3)c2)cc1 ; CCN(CC)c1ccc(-c2cc(-c3cccc(Cl)c3)nc(-c3cccc(Cl)c3)c2)cc1 ; CCN(CC)c1ccc(-c2cc(-c3ccc4ccccc4c3)nc(-c3ccc4ccccc4c3)c2)cc1]

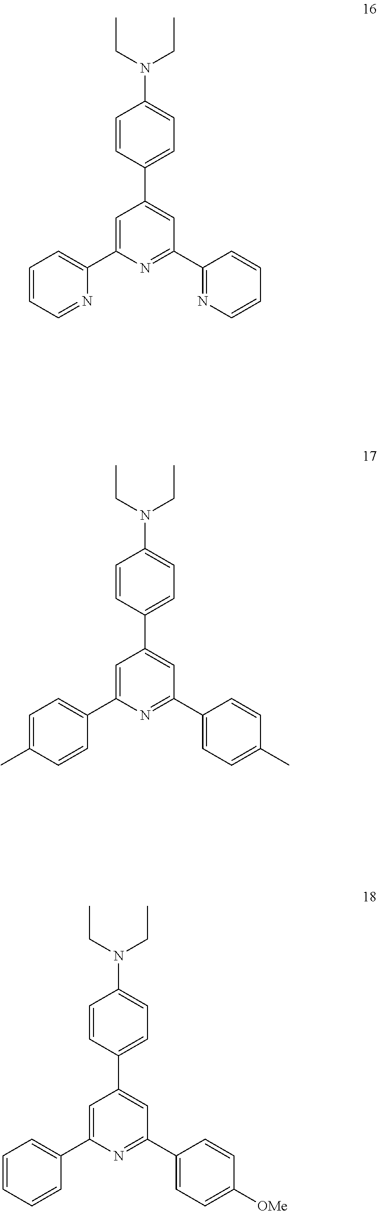

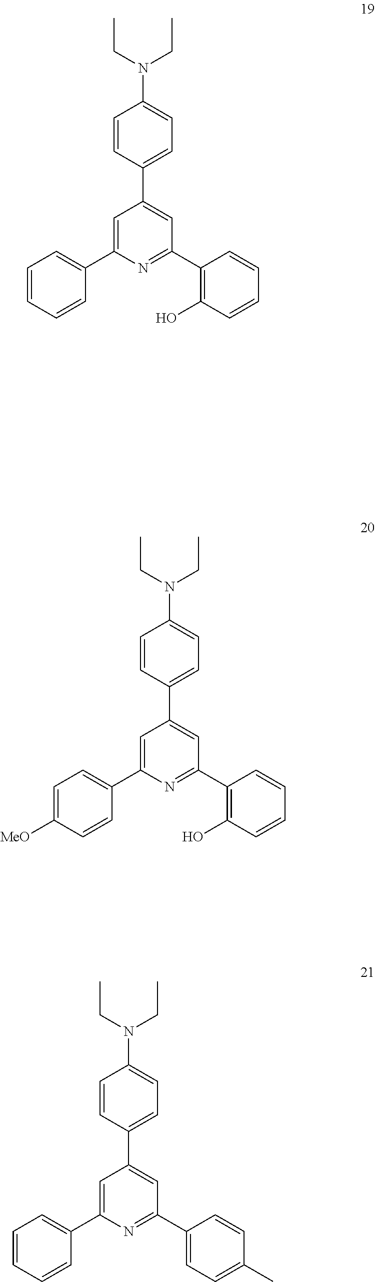 [SMILES: CCN(CC)c1ccc(-c2cc(-c3ccccc3)nc(-c3ccccc3O)c2)cc1 ; CCN(CC)c1ccc(-c2cc(-c3ccc(OC)cc3)nc(-c3ccccc3O)c2)cc1 ; CCN(CC)c1ccc(-c2cc(-c3ccccc3)nc(-c3ccc(C)cc3)c2)cc1]

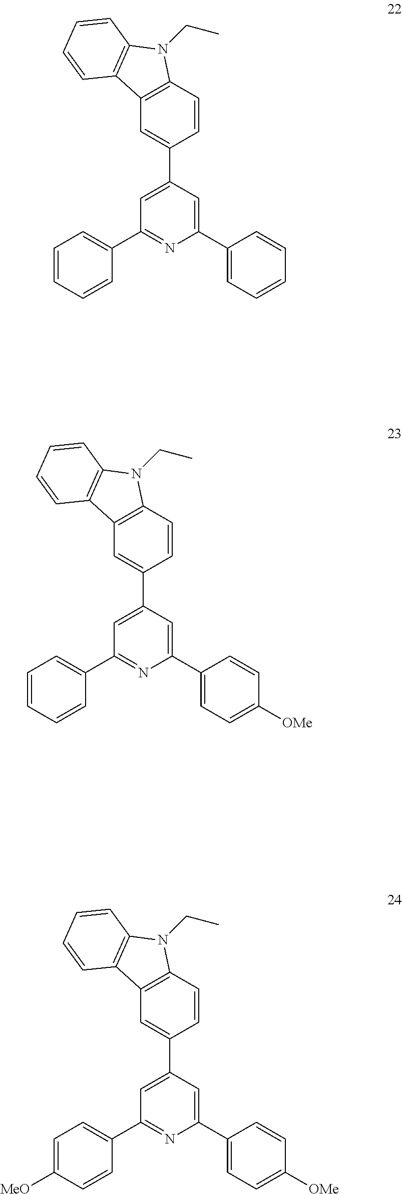 [SMILES: CCn1c2ccccc2c2cc(-c3cc(-c4ccccc4)nc(-c4ccccc4)c3)ccc21 ; CCn1c2ccccc2c2cc(-c3cc(-c4ccccc4)nc(-c4ccc(OC)cc4)c3)ccc21 ; CCn1c2ccccc2c2cc(-c3cc(-c4ccc(OC)cc4)nc(-c4ccc(OC)cc4)c3)ccc21]

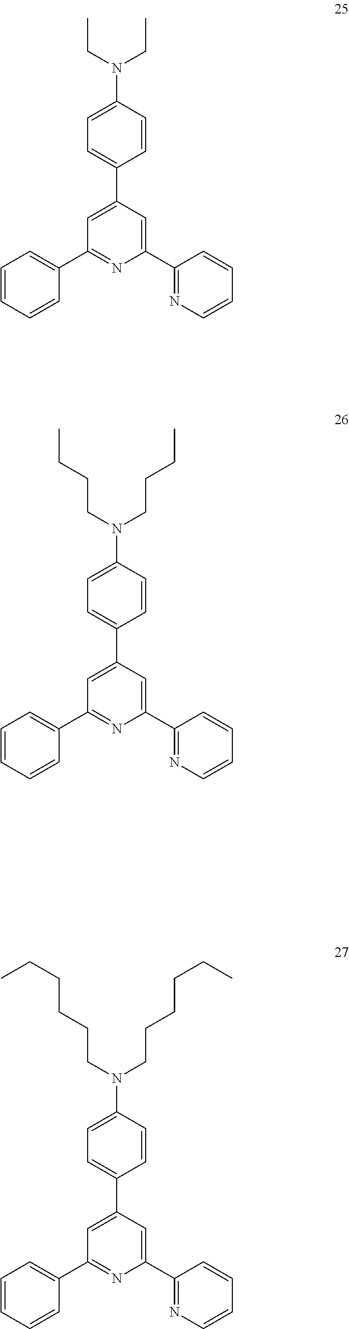 [SMILES: CCN(CC)c1ccc(-c2cc(-c3ccccc3)nc(-c3ccccn3)c2)cc1 ; CCCCN(CCCC)c1ccc(-c2cc(-c3ccccc3)nc(-c3ccccn3)c2)cc1 ; CCCCCCN(CCCCCC)c1ccc(-c2cc(-c3ccccc3)nc(-c3ccccn3)c2)cc1]

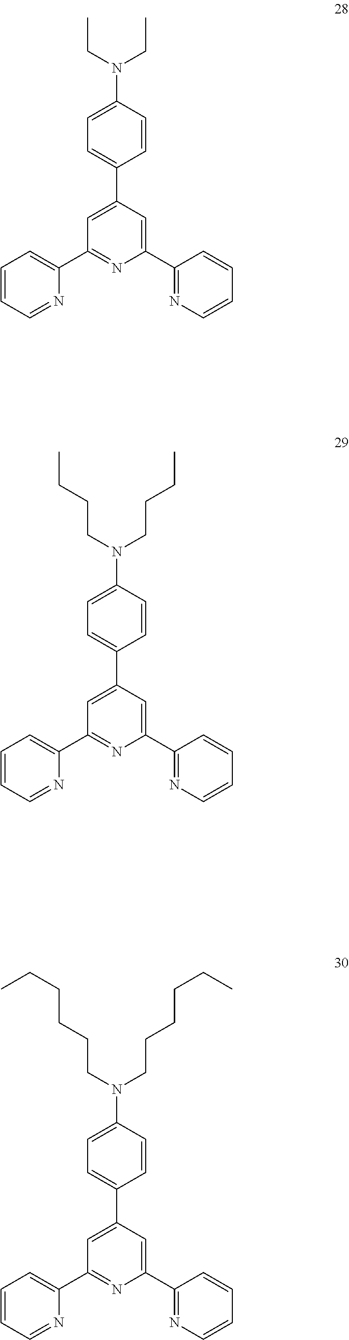 [SMILES: CCN(CC)c1ccc(-c2cc(-c3ccccn3)nc(-c3ccccn3)c2)cc1 ; CCCCN(CCCC)c1ccc(-c2cc(-c3ccccn3)nc(-c3ccccn3)c2)cc1 ; CCCCCCN(CCCCCC)c1ccc(-c2cc(-c3ccccn3)nc(-c3ccccn3)c2)cc1]

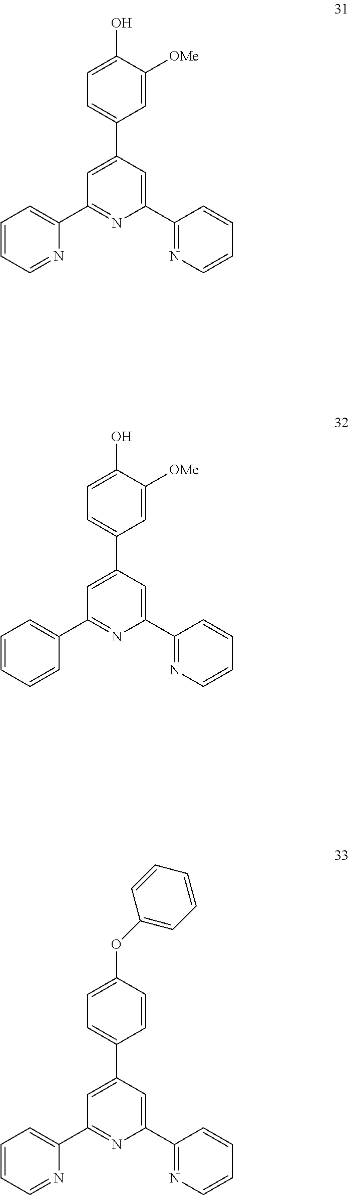 [SMILES: COc1cc(-c2cc(-c3ccccn3)nc(-c3ccccn3)c2)ccc1O ; COc1cc(-c2cc(-c3ccccc3)nc(-c3ccccn3)c2)ccc1O ; c1ccc(Oc2ccc(-c3cc(-c4ccccn4)nc(-c4ccccn4)c3)cc2)cc1]

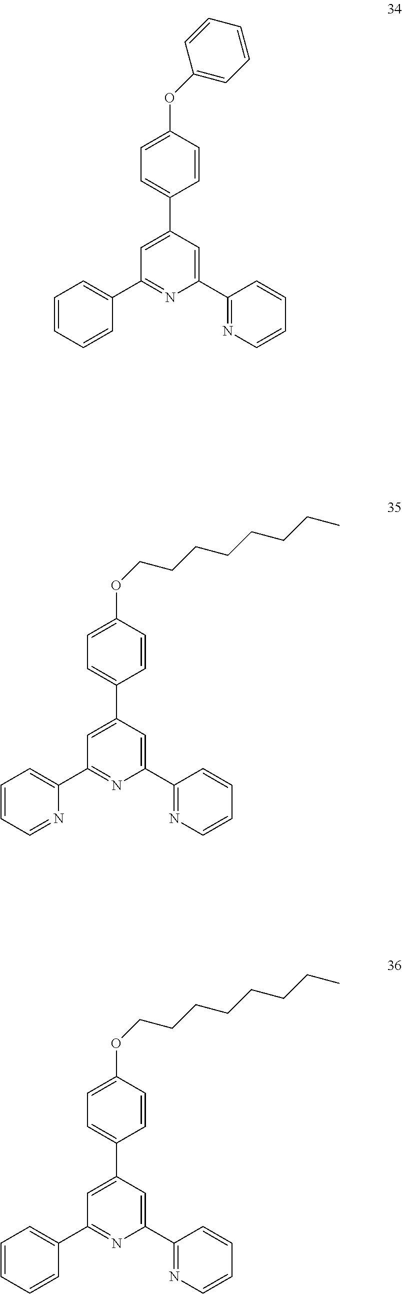 [SMILES: c1ccc(Oc2ccc(-c3cc(-c4ccccc4)nc(-c4ccccn4)c3)cc2)cc1 ; CCCCCCCCOc1ccc(-c2cc(-c3ccccn3)nc(-c3ccccn3)c2)cc1 ; CCCCCCCCOc1ccc(-c2cc(-c3ccccc3)nc(-c3ccccn3)c2)cc1]

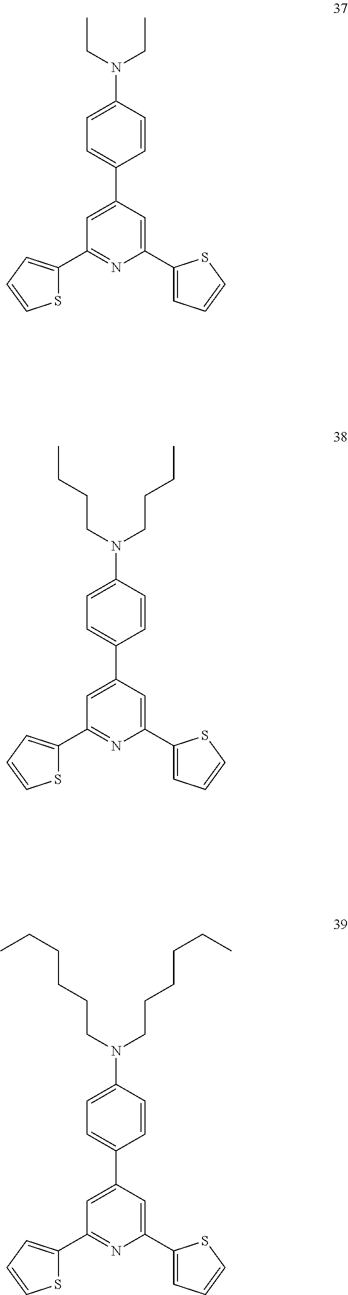 [SMILES: CCN(CC)c1ccc(-c2cc(-c3cccs3)nc(-c3cccs3)c2)cc1 ; CCCCN(CCCC)c1ccc(-c2cc(-c3cccs3)nc(-c3cccs3)c2)cc1 ; CCCCCCN(CCCCCC)c1ccc(-c2cc(-c3cccs3)nc(-c3cccs3)c2)cc1]

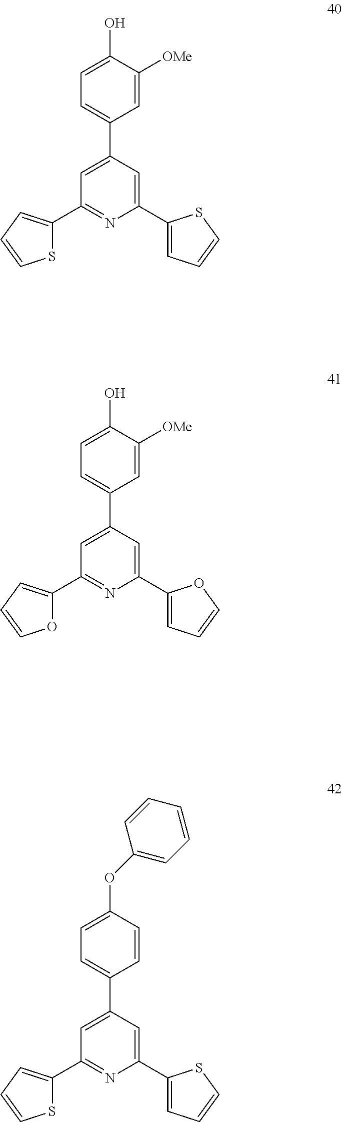 [SMILES: COc1cc(-c2cc(-c3cccs3)nc(-c3cccs3)c2)ccc1O ; COc1cc(-c2cc(-c3ccco3)nc(-c3ccco3)c2)ccc1O ; c1ccc(Oc2ccc(-c3cc(-c4cccs4)nc(-c4cccs4)c3)cc2)cc1]

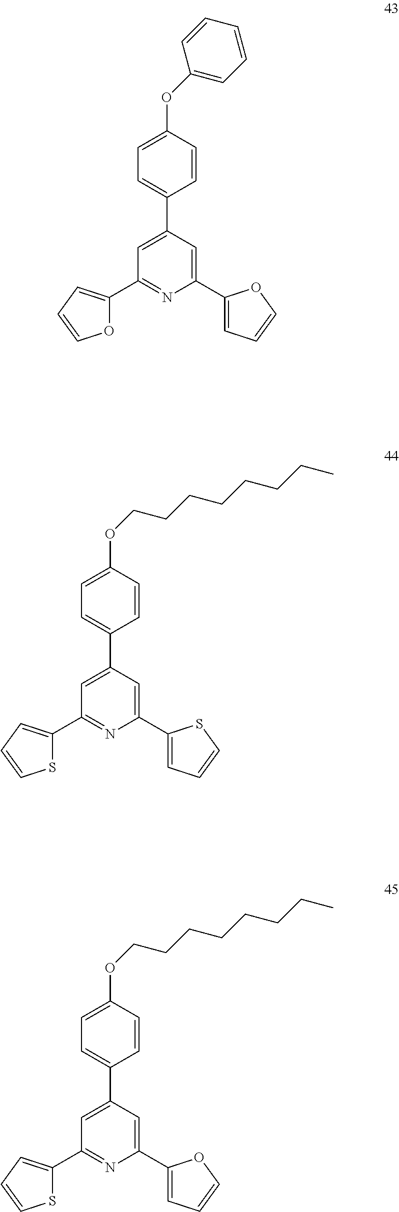 [SMILES: c1ccc(Oc2ccc(-c3cc(-c4ccco4)nc(-c4ccco4)c3)cc2)cc1 ; CCCCCCCCOc1ccc(-c2cc(-c3cccs3)nc(-c3cccs3)c2)cc1 ; CCCCCCCCOc1ccc(-c2cc(-c3ccco3)nc(-c3cccs3)c2)cc1]

4,4′-dialkyl-2,2′-biphenol,
4,4′-dichloro, difluoro, dibromo, diiodo-2,2′-biphenol,
4,4′-dicarboalkoxy-2,2′-biphenol, and
4,4′-diacetyl, dibenzoyl-2,2′-biphenol and 5-alkyl-salicylic acid.

### Developers

Weak acids that can be used as color developers act as proton donors, changing the dye molecule between its leuco form and its protonated colored form; stronger acids make the change irreversible. Examples of developers used in the present disclosure include but are not limited to: bisphenol A; bisphenol F; tetrabromobisphenol A; 1′-methylenedi-2-naphthol; 1,1,1-tris(4-hydroxyphenyl)ethane; 1,1-bis(3-cyclohexyl-4-hydroxyphenyl)cyclohexane; 1,1-bis(4-hydroxy-3-methylphenyl)cyclohexane; 1,1-bis(4-hydroxyphenyl)cyclohexane; 1,3-bis[2-(4-hydroxyphenyl)-2-propyl]benzene; 1-naphthol; 2-naphthol; 2,2 bis(2-hydroxy-5-biphenylyl)propane; 2,2-bis(3-cyclohexyl-4-hydroxy)propane; 2,2-bis(3-sec-butyl-4-hydroxyphenyl)propane; 2,2-bis(4-hydroxy-3-isopropylphenyl)propane; 2,2-bis(4-hydroxy-3-methylphenyl)propane; 2,2-bis(4-hydroxyphenyl)propane; 2,3,4-trihydroxydiphenylmethane; 4,4′-(1,3-Dimethylbutylidene)diphenol; 4,4′-(2-Ethylidene)diphenol; 4,4′-(2-hydroxybenzylidene)bis(2,3,6-trimethylphenol); 4,4′-biphenol; 4,4′-dihydroxydiphenyl ether; 4,4′-dihydroxydiphenylmethane; 4,4′-methylidenebis(2-methylphenol); 4-(1,1,3,3-tetramethylbutyl)phenol; 4-phenylphenol; 4-tert-butylphenol; 9,9-bis(4-hydroxyphenyl)fluorine; 4,4′-(ethane-1,1-diyl)diphenol; alpha,alpha′-bis(4-hydroxyphenyl)-1,4-diisopropylbenzene; alpha,alpha,alpha′-tris(4-hydroxyphenyl)-1-ethyl-4-isopropylbenzene; benzyl 4-hydroxybenzoate; bis(4-hydroxyphenyl)sulfide; bis(4-hydroxyphenyl)sulfone; propyl 4-hydroxybenzoate; methyl 4-hydroxybenzoate; resorcinol; 4-tert-butyl-catechol; 4-tert-butyl-benzoic acid; 1,1′-methylenedi-2-naphthol 1,1,1-tris(4-hydroxyphenyl)ethane; 1,1-bis(3-cyclohexyl-4-hydroxyphenyl)cyclohexane; 1,1-bis(4-hydroxy-3-methylphenyl)cyclohexane; 1,1-bis(4-hydroxyphenyl)cyclohexane; 1,3-bis[2-(4-hydroxyphenyl)-2-propyl]benzene; 1-naphthol 2,2′-biphenol; 2,2-bis(2-hydroxy-5-biphenylyl)propane; 2,2-bis(3-cyclohexyl-4-hydroxyphenyl)propane; 2,2-bis(3-sec-butyl-4-hydroxyphenyl)propane; 2,2-bis(4-hydroxy-3-isopropylphenyl)propane; 2,2-bis(4-hydroxy-3-methylphenyl)propane; 2,2-bis(4-hydroxyphenyl)propane; 2,3,4-trihydroxydiphenylmethane; 2-naphthol; 4,4′-(1,3-dimethylbutylidene)diphenol; 4,4′-(2-ethylhexylidene)diphenol 4,4′-(2-hydroxybenzylidene)bis(2,3,6-trimethylphenol); 4,4′-biphenol; 4,4′-dihydroxydiphenyl ether; 4,4′-dihydroxydiphenylmethane; 4,4′-ethylidenebisphenol; 4,4′-methylenebis(2-methylphenol); 4-(1,1,3,3-tetramethylbutyl)phenol; 4-phenylphenol; 4-tert-butylphenol; 9,9-bis(4-hydroxyphenyl)fluorine; alpha,alpha′-bis(4-hydroxyphenyl)-1,4-diisopropylbenzene; α,α,α-tris(4-hydroxyphenyl)-1-ethyl-4-isopropylbenzene; benzyl 4-hydroxybenzoate; bis(4-hydroxyphenyl)sulfidem; bis(4-hydroxyphenyl)sulfone methyl 4-hydroxybenzoate; resorcinol; tetrabromobisphenol A; derivative salts of salicylic acid such as 3,5-di-tertbutyl-salicylic acid; zinc 3,5-di-tertbutylsalicylate; 3-phenyl-salicylic acid; 5-tertbutyl-salicylic acid; 5-n-octyl-salicylic acid; 2,2′-biphenol; 4,4′-di-tertbutyl-2,2′-biphenol; 4,4′-di-n-alkyl-2,2′-biphenol; and 4,4′-di-halo-2,2′-biphenol, wherein the halo is chloro, fluoro, bromo, or iodo.

Specific examples of known leuco dye developers are shown below:

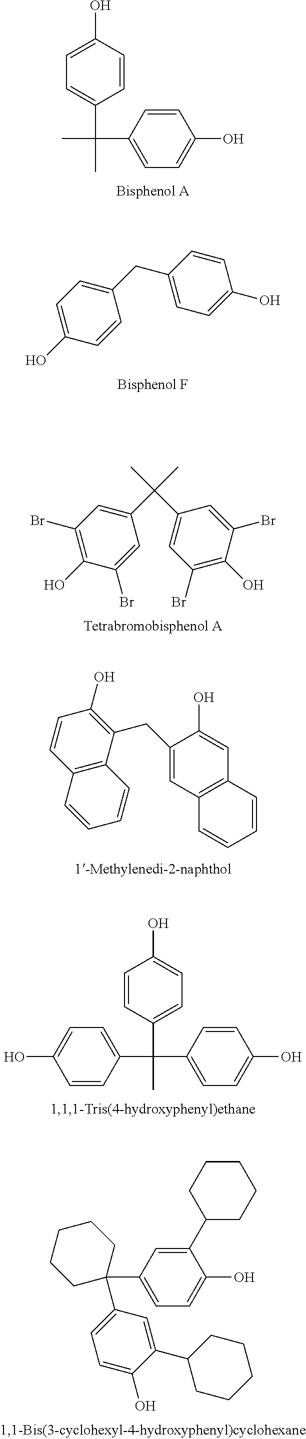 [SMILES: CC(C)(c1ccc(O)cc1)c1ccc(O)cc1 ; Oc1ccc(Cc2ccc(O)cc2)cc1 ; CC(C)(c1cc(Br)c(O)c(Br)c1)c1cc(Br)c(O)c(Br)c1 ; Oc1cc2ccccc2cc1Cc1c(O)ccc2ccccc12 ; CC(c1ccc(O)cc1)(c1ccc(O)cc1)c1ccc(O)cc1 ; Oc1ccc(C2(c3ccc(O)c(C4CCCCC4)c3)CCCCC2)cc1C1CCCCC1]

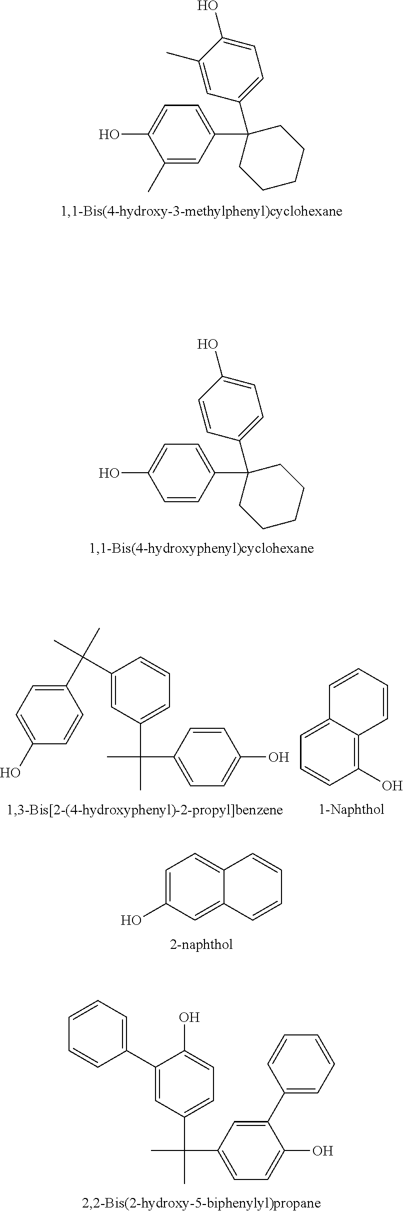

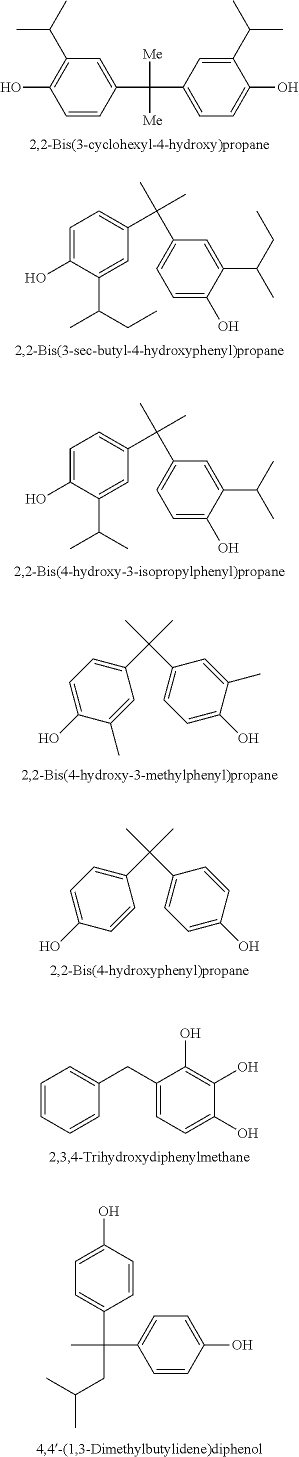

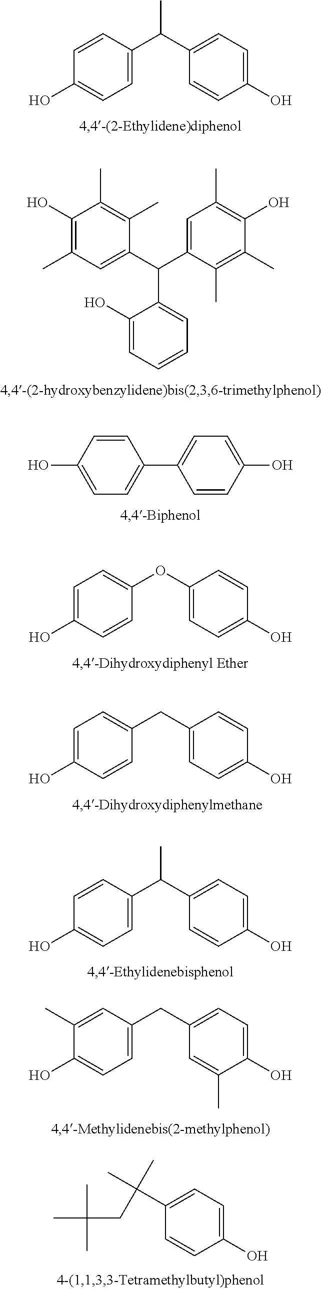

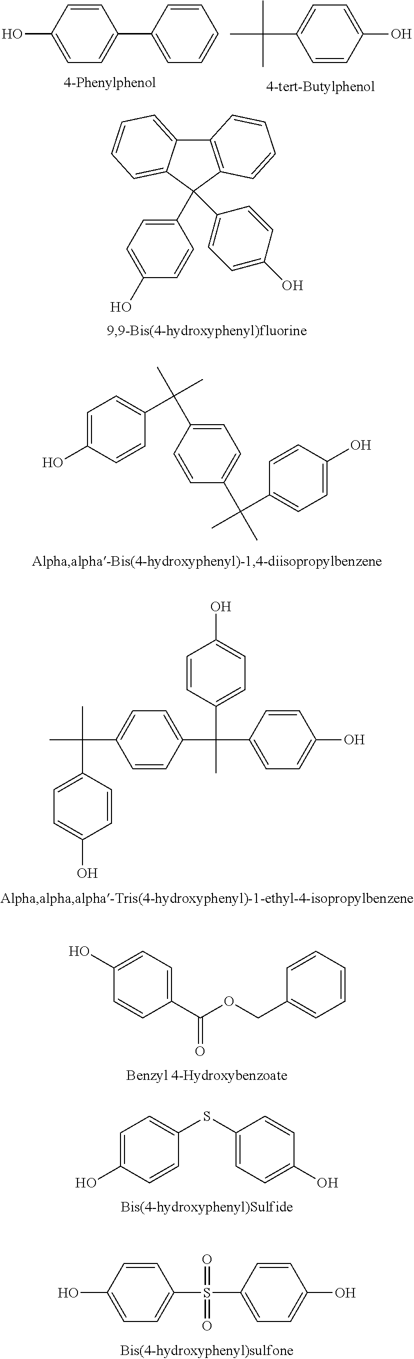

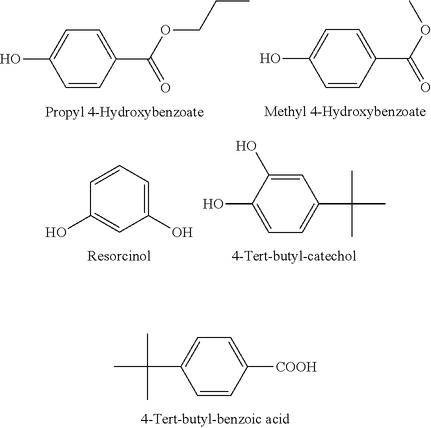

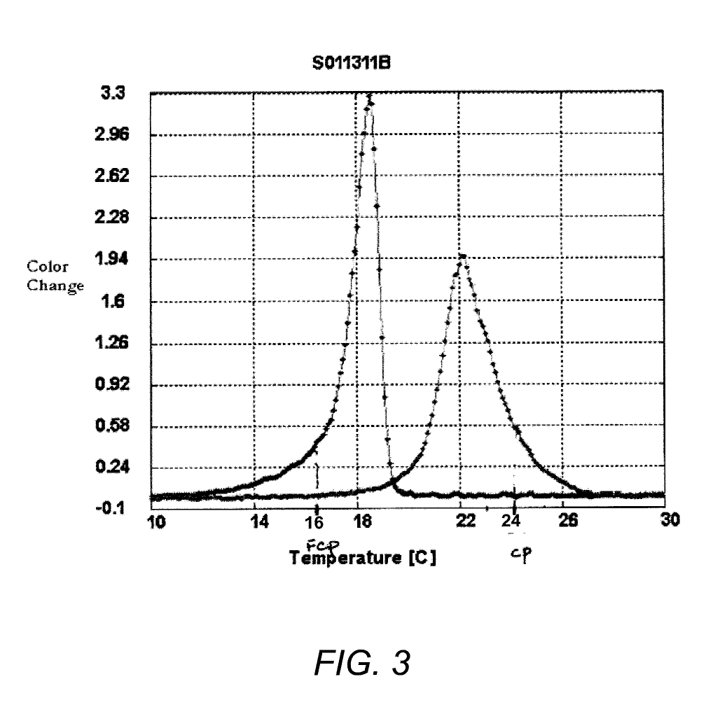

The leuco dyes are combined with leuco dye developers for making thermochromic compositions. These materials are found to generate absorption densities from the leuco dyes when formulated with a carrier that contains one or more fatty ester, fatty alcohol, and fatty amide. The combination of leuco dyes, developers and carrier materials may be used in any combination to achieve the listed functionalities. By way of example, this combination of molecules includes any combination of the following molecules: bipyridyl and terpyridine leuco dyes of the type 2-[2-pyridyl]-6-phenyl-4-dialkylamino-pyridine, 2-[2-pyridyl]-6-phenyl-4-diarylamino-pyridine, 2-[2-pyridyl]-6-phenyl-4-hydroxy-pyridine, 2-[2-pyridyl]-6-[2-pyridyl]-4-dialkylamino-pyridine, 2-[2-pyridyl]-6-[2-pyridyl]-4-diarylamino-pyridine, 2-[2-pyridyl]-6-[2-pyridyl]-4-hydroxy-pyridine, molecules from FIG. 3 including at least the following; 26, 27, 29, 30, 31, 32, 33, 34, 35, 36, 38, 39, 41, 42, and 43; also 2,6-diphenyl-4-dialkylamino-pyridines, 2,6-diphenyl-4-diarylamino-pyridines, 2,6-diphenyl-4-hydroxy-pyridines, 2,6-diphenyl-4-alkoxy-pyridines, 2,6-diphenyl-4-aryloxy-pyridines, molecules from FIG. 3 including at least the following; 1, 3, 5, 6, 7, 8, 9, 10, 13, 17, 19, 20, 21, 22, 23, 24; and 4,4′-dialkyl-2,2′-biphenol, 4,4′-dichloro, difluoro, dibromo, diiodo-2,2′-biphenol, 4,4′-dicarboalkoxy-2,2′-biphenol, 4,4′-diacetyl, dibenzoyl-2,2′-biphenol as well as salicylic acids including at least 5-alkyl-salicylic acid.

Furthermore the composition so obtained may be encapsulated in a separate composition, such as a melamine-formaldehyde resin, to produce absorption changing pigments designed for use in formulated ink and coating products as well as plastic pellet concentrates for injection molded or extruded plastic products.

Some materials function as both leuco dyes and light absorbers:

### Visible Range Absorbers (400 nm to 700 nm):

4-(4′-dimethylamino-phenyl)-2,6-diphenyl-pyridine (dye 11)
4-(4′-diphenylamino-phenyl)-2,6-diphenyl-pyridine (dye 3)

### Near UVA Range Absorbers:

4-(4-ethoxy-phenyl)-2,6-diphenyl-pyridine (dye 1).
4-(4-phenoxy-phenyl)-2,6-diphenyl-pyridine (dye 3).

These developers are particularly preferred for use with the 2,4,6 tri-substituted pyridine dyes

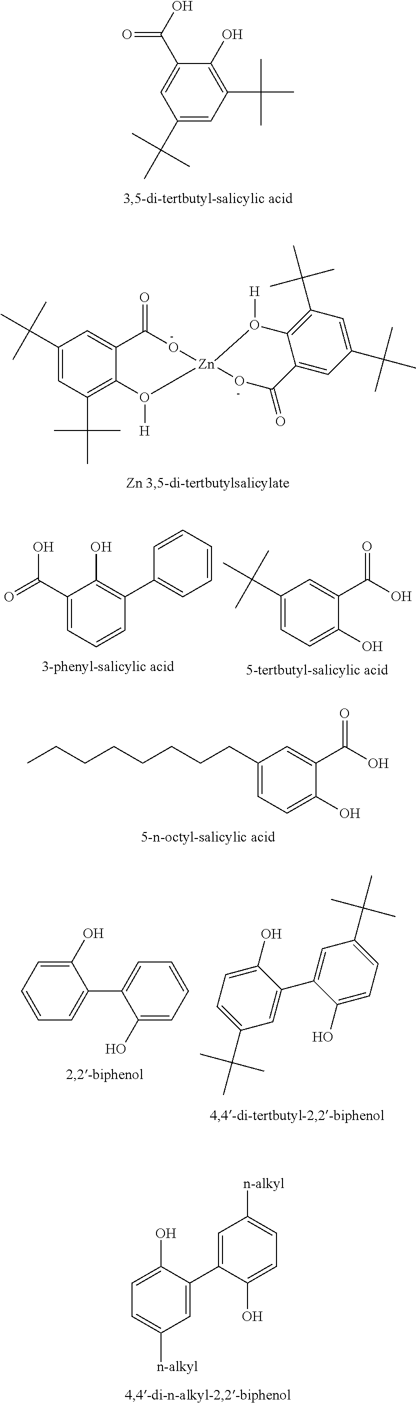

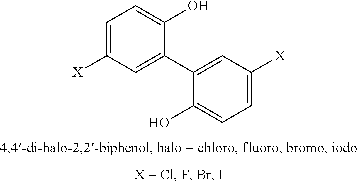

### Solvents

The best solvents to use within the thermochromic system are those that have low reactivity, have a relatively large molecular weight (i.e. over 100), and which are relatively non-polar. Ketones, diols and aromatic compounds should not be used as solvents within the thermochromic system.

Solvents and/or co-solvents used in thermochromic generally may include, but are not limited to: aldehydes, thiols, sulfides, ethers, ketones, esters, alcohols, and acid amides. These solvents can be used alone or in mixtures of 2 or more. Examples of the sulfides include, but are not limited to: di-n-octyl sulfide; di-n-nonyl sulfide; di-n-decyl sulfide; di-n-dodecyl sulfide; di-n-tetradecyl sulfide; di-n-hexadecyl sulfide; di-n-octadecyl sulfide; octyl dodecyl sulfide; diphenyl sulfide; dibenzyl sulfide; ditolyl sulfide; diethylphenyl sulfide; dinaphthyl sulfide; 4,4′-dichlorodiphenyl sulfide; and 2,4,5,4′tetrachlorodiphenyl sulfide. Examples of the ethers include, but are not limited to: aliphatic ethers having 10 or more carbon atoms, such as dipentyl ether, dihexyl ether, diheptyl ether, dioctyl ether, dinonyl ether, didecyl ether, diundecyl ether, didodecyl ether, ditridecyl ether, ditetradecyl ether, dipentadecyl ether, dihexadecyl ether, dioctadecyl ether, decanediol dimethyl ether, undecanediol dimethyl ether, dodecanediol dimethyl ether, tridecanediol dimethyl ether, decanediol diethyl ether, and undecanediol diethyl ether; alicyclic ethers such as s-trioxane; and aromatic ethers such as phenylether, benzyl phenyl ether, dibenzyl ether, di-p-tolyl ether, 1-methoxynaphthalene, and 3,4,5trimethoxytoluene.

Examples of ketone solvents include, but are not limited to: aliphatic ketones having 10 or more carbon atoms, such as 2-decanone, 3-decanone, 4-decanone, 2-undecanone, 3-undecanone, 4-undecanone, 5-undecanone, 6-undecanone, 2-dodecanone, 3-dodecanone, 4-dodecanone, 5-dodecanone, 2-tridecanone, 3-tridecanone, 2-tetradecanone, 2-pentadecanone, 8-pentadecanone, 2-hexadecanone, 3-hexadecanone, 9-heptadecanone, 2-pentadecanone, 2-octadecanone, 2-nonadecanone, 10-nonadecanone, 2-eicosanone, 11-eicosanone, 2-heneicosanone, 2-docosanone, laurone, and stearone; aryl alkyl ketones having 12 to 24 carbon atoms, such as n-octadecanophenone, n-heptadecanophenone, n-hexadecanophenone, n-pentadecanophenone, n-tetradecanophenone, 4-n-dodecaacetophenone, n-tridecanophenone, 4-n-undecanoacetophenone, n-laurophenone, 4-n-decanoacetophenone, n-undecanophenone, 4-n-nonylacetophenone, n-decanophenone, 4-n-octylacetophenone, n-nonanophenone, 4-n-heptylacetophenone, n-octanophenone, 4-n-hexylacetophenone, 4-n-cyclohexylacetophenone, 4-tert-butylpropiophenone, n-heptaphenone, 4-n-pentylacetophenone, cyclohexyl phenyl ketone, benzyl n-butyl ketone, 4-n-butylacetophenone, n-hexanophenone, 4-isobutylacetophenone, 1-acetonaphthone, 2-acetonaphthone, and cyclopentyl phenyl ketone; aryl aryl ketones such as benzophenone, benzyl phenyl ketone, and dibenzyl ketone; and alicyclic ketones such as cyclooctanone, cyclododecanone, cyclopentadecanone, and 4-tert-butylcyclohexanone, ethyl caprylate, octyl caprylate, stearyl caprylate, myristyl caprate, stearyl caprate, docosyl caprate, 2-ethylhexyl laurate, n-decyl laurate, 3-methylbutyl myristate, cetyl myristate, isopropyl palmitate, neopentyl palmitate, nonyl palmitate, cyclohexyl palmitate, n-butyl stearate, 2-methylbutyl stearate, stearyl behenate 3,5,5-trimethylhexyl stearate, n-undecyl stearate, pentadecyl stearate, stearyl stearate, cyclohexylmethyl stearate, isopropyl behenate, hexyl behenate, lauryl behenate, behenyl behenate, cetyl benzoate, stearyl p-tert-butylbenzoate, dimyristyl phthalate, distearyl phthalate, dimyristyl oxalate, dicetyl oxalate, dicetyl malonate, dilauryl succinate, dilauryl glutarate, diundecyl adipate, dilauryl azelate, di-n-nonyl sebacate, 1,18-dineopentyloctadecylmethylenedicarboxylate, ethylene glycol dimyristate, propylene glycol dilaurate, propylene glycol distearate, hexylene glycol dipalmitate, 1,5-pentanediol dimyristate, 1,2,6-hexanetriol trimyristate, 1,4-cyclohexanediol didecanoate, 1,4-cyclohexanedimethanol dimyristate, xylene glycol dicaprate, and xylene glycol distearate.

Without limitation, ester solvents may be selected from esters of a saturated fatty acid with a branched aliphatic alcohol, esters of an unsaturated fatty acid or a saturated fatty acid having one or more branches or substituents with an aliphatic alcohol having one or more branches or 16 or more carbon atoms, cetyl butyrate, stearyl butyrate, and behenyl butyrate including 2-ethylhexyl butyrate, 2-ethylhexyl behenate, 2-ethylhexyl myristate, 2-ethylhexyl caprate, 3,5,5-trimethylhexyl laurate, 3,5,5-trimethylhexyl palmitate, 3,5,5-trimethylhexyl stearate, 2-methylbutyl caproate, 2-methylbutyl caprylate, 2-methylbutyl caprate, 1-ethylpropyl palmitate, 1-ethylpropyl stearate, 1-ethylpropyl behenate, 1-ethylhexyl laurate, 1-ethylhexyl myristate, 1-ethylhexyl palmitate, 2-methylpentyl caproate, 2-methylpentyl caprylate, 2-methylpentyl caprate, 2-methylpentyl laurate, 2-methylbutyl stearate, 2-methylbutyl stearate, 3-methylbutyl stearate, 2-methylheptyl stearate, 2-methylbutyl behenate, 3-methylbutyl behenate, 1-methylheptyl stearate, 1-methylheptyl behenate, 1-ethylpentyl caproate, 1-ethylpentyl palmitate, 1-methylpropyl stearate, 1-methyloctyl stearate, 1-methylhexyl stearate, 1,1dimethylpropyl laurate, 1-methylpentyl caprate, 2-methylhexyl palmitate, 2-methylhexyl stearate, 2-methylhexyl behenate, 3,7-dimethyloctyl laurate, 3,7-dimethyloctyl myristate, 3,7-dimethyloctyl palmitate, 3,7-dimethyloctyl stearate, 3,7-dimethyloctyl behenate, stearyl oleate, behenyl oleate, stearyl linoleate, behenyl linoleate, 3,7-dimethyloctyl erucate, stearyl erucate, isostearyl erucate, cetyl isostearate, stearyl isostearate, 2-methylpentyl 12-hydroxystearate, 2-ethylhexyl 18-bromostearate, isostearyl 2-ketomyristate, 2-ethylhexyl-2-fluoromyristate, cetyl butyrate, stearyl butyrate, and behenyl butyrate.

Examples of the alcohol solvents include, without limitation, monohydric aliphatic saturated alcohols such as decyl alcohol, undecyl alcohol, dodecyl alcohol, tridecyl alcohol, tetradecyl alcohol, pentadecyl alcohol, hexadecyl alcohol, heptadecyl alcohol, octadecyl alcohol, eicosyl alcohol, behenyl alcohol and docosyl alcohol; aliphatic unsaturated alcohols such as allyl alcohol and oleyl alcohol, alicyclic alcohols such as cyclopentanol, cyclohexanol, cyclooctanol, cyclododecanol, and 4-tert-butylcyclohexanol; aromatic alcohols such as 4-methylbenzyl alcohol and benzhydrol; and polyhydric alcohols such as polyethylene glycol. Examples of the acid amides include, but are not limited to: acetamide, propionamide, butyramide, capronamide, caprylamide, capric amide, lauramide, myristamide, palmitamide, stearamide, behenamide, oleamide, erucamide, benzamide, capronanilide, caprylanilide, capric anilide, lauranilide, myristanilide, palmitanilide, stearanilide, behenanilide, oleanilide, erucanilide, N-methylcapronamide, N-methylcaprylamide, N-methyl (capric amide), N-methyllauramide, N-methylmyristamide, N-methylpalmitamide, N-methylstearamide, N-methylbehenamide, N-methyloleamide, N-methylerucamide, N-ethyllauramide, N-ethylmyristamide, N-ethylpalmitamide, N-ethylstearamide, N-ethyloleamide, N-butyllauramide, N-butylmyristamide, N-butylpalmitamide, N-butylstearamide, N-butyloleamide, N-octyllauramide, N-octylmyristamide, N-octylpalmitamide, N-octylstearamide, N-octyloleamide, N-dodecyllauramide, N-dodecylmyristamide, N-dodecylpalmitamide, N-dodecylstearamide, N-dodecyloleamide, dilauroylamine, dimyristoylamine, dipalmitoylamine, distearoylamine, dioleoylamine, trilauroylamine, trimyristoylamine, tripalmitoylamine, tristearoylamine, trioleoylamine, succinamide, adipamide, glutaramide, malonamide, azelamide, maleamide, N-methylsuccinamide, N-methyladip amide, N-methylglutaramide, N-methylmalonamide, N-methylazelamide, N-ethylsuccinamide, N-ethyladipamide, N-ethylglutaramide, N-ethylmalonamide, N-ethylazelamide, N-butylsuccinamide, N-butyladipamide, N-butylglutaramide, N-butylmalonamide, N-octyladipamide, and N-dodecyladipamide.

To our surprise, among these solvents, it has been discovered that certain solvents reduce the hysteresis window. The solvent may be material combined with the thermochromic system, for example, to reduce thermal separation across the hysteresis window to a level demonstrating 80%, 70%, 50%, 40%, 30% or less of the thermal separation that would exist if the co-solvent were not present. The co-solvent is selected from the group consisting of derivatives of mysristic acid, derivatives of behenyl acid, derivatives of palmytic acid and combinations thereof. Generally, these materials include myristates, palmitates, behenates, together with myristyl, stearyl, and behenyl materials and certain alcohols. In one aspect, these materials are preferably solvents and co-solvents from the group including isopropyl myristate, isopropyl palmitate, methyl palmitate, methyl stearate, myristyl myristate, cetyl alcohol, stearyl alcohol, behenyl alcohol, stearyl behenate, and stearamide. These co-solvents are added to the encapsulated thermochromic system in an amount that, for example, ranges from 9% to 18% by weight of the thermochromic system as encapsulated, i.e., excluding the weight of the capsule. This range is more preferably from about 12% to about 15% by weight.

### Light Stabilizers

In other instances, additives used to fortify the encapsulated thermochromic systems by imparting a resistance to degradation by ultraviolet light by have a dual functionality of also reducing the with of separation over the hysteresis window. Light stabilizers are additives which prevent degradation of a product due to exposure to ultraviolet radiation. These compounds may include blocked phenols, singlet oxygen quenchers, UVA/B absorbers, borotriazoles, and hindered amino light stabilizers (HALS). Specific examples of light stabilizers used in thermochromic systems of the present disclosure and which may also influence the hysteresis window include but are not limited to: avobenzone, bisdisulizole disodium, diethylaminohydroxybenzoyl hexyl benzoate, Ecamsule, methyl anthranilate, 4-aminobenzoic acid, Cinoxate, ethylhexyl triazone, homosalate, 4-methylbenzylidene camphor, octyl methoxycinnamate, octyl salicylate, Padimate O, phenylbenzimidazole sulfonic acid, polysilicone-15, trolamine salicylate, bemotrizinol, benzophenones 1-12, dioxybenzone, drometrizole trisiloxane, iscotrizinol, octocrylene, tetrakis-(methylene-(3,5-di-(tert)-butyl-4-hydrocinnamate))methane, oxybenzone, sulisobenzone, bisoctrizole, titanium dioxide, zinc oxide, and sterically hindered phenols such as pentaerythritol tetrakis(3-(3,5-di-tert-butyl-4-hydroxyphenyl)propionate sold as Irganox 1010® by Ciba Specialty Chemicals Inc. of Tarrytown N.Y.

### Encapsulation Process

Nearly all thermochromic systems require encapsulation for protection. As is known in the art, the most common process for encapsulation is interfacial polymerization, although encapsulation is not limited to interfacial polymerization. During interfacial polymerization the internal phase (material inside the capsule), external phase (wall material of the capsule) and water are combined under homogenization through high-speed mixing. By controlling all the temperature, pH, concentrations, and mixing speed precisely, the external phase will surround the internal phase droplet while crosslinking with itself. Usually the capsules are between 3-5 μm or smaller. Such small sizes of capsules are referred to as microcapsules and the thermochromic system within the microcapsules are microencapsulated. Microencapsulation allows thermochromic systems to be used in wide range of materials and products. The size of the microcapsules requires some adjustments to suit particular printing and manufacturing processes.

The size distribution of preferred microcapsules can range from as much as 0.2 μm to 100 μm. Further example techniques of physical microencapsulation include but are not limited to pan coating, air suspension coating, centrifugal extrusion, vibration nozzle, and spray drying. Examples of chemical microencapsulation techniques include but are not limited to interfacial polymerization, in-situ polymerization, and matrix polymerization. Example polymers used in the preferred chemical microencapsulation include but are not limited to polyester, polyurethane, polyureas, urea-formaldehyde, epoxy, melamine-formaldehyde, polyethylene, polyisocyanates, polystyrene, polyamides, and polysilanes.

The capsule isolates the thermochromic system from the environment, but the barrier that the capsule provides is itself soluble to certain solvents. Therefore, the microcapsule constituents interact with the environment to some extent. The solubility parameter describes how much a material will swell in the presence of different solvents. This swelling will directly impact the characteristics of the reaction potential within the capsule, as well as potentially making the capsule more permeable, both of which will likely adversely affect the thermochromic system. Solvents in which the microcapsules are exposed to are chosen so as not to destroy, or affect, the thermochromic system within.

The capsule is hard, thermally stable and relatively impermeable. The infiltration of compounds through the capsule are stopped or slowed to the point that the characteristics of the dye are not affected. The pollution of the thermochromic system within the capsule by solvents from the environment affects the shelf life of the thermochromic system. Therefore, the formulation of the applied thermochromic system, as an ink for example, should be carefully considered.

In an embodiment of the present disclosure, capsules are made from melamine formaldehyde. One technique used to produce the encapsulated thermochromic systems is to combine water, dye, oil, and melamine formaldehyde and agitate to create a very fine emulsification. Because of the properties of the compounds, the oil and dye end up on the inside of the capsule and the water ends up on the outside, with the melamine formaldehyde making up the capsule itself. The capsule can then be thermo-set, similar to other resins, such as formica. The thermo-set substance is very hard and will not break down, even at temperatures higher than the encapsulated thermochromic system is designed to be exposed to. The melamine formaldehyde capsule is almost entirely insoluble in most solvents, but it is permeable to certain solvents that might destroy the ability of the thermochromic system to color and decolorize throughout a temperature range.

The extent to which capsules will react with their environment is influenced by the pH of the surrounding medium, the permeability of the capsule, the polarity and reactivity of compounds in the medium, and the solubility of the capsule. Preferred media used in formulating encapsulated thermochromic system are engineered to reduce the reactivity between that medium and the capsules to a low enough level that the reactivity will not influence the characteristics of the dye for an extended period of time.

Highly polar solvent molecules, with the exception of water, often interact more with the leuco dye than with the capsule shell and other non-polar molecules of the thermochromic system. Therefore, polar solvents that are able to cross the capsule barrier should, in general, be eliminated from the medium within which the encapsulated thermochromic system is formulated.

Ideally, aqueous media that the encapsulated thermochromic systems are placed within should have a narrow pH range from about 6.5 to about 7.5. When an encapsulated thermochromic system is added to a formulation that has a pH outside this range, often the thermochromic properties of the system are destroyed. This is an irreversible effect.

One aspect of the present disclosure is for a method of improving the formulations of the thermochromic system by removing any aldehydes, ketones, and diols and replacing them with solvents which do not adversely effect the thermochromic system. Solvents having a large molecular weight (i.e. greater than 100) generally are compatible with the thermochromic systems. The acid content of the system is preferably adjusted to an acid number below 20 or preferably adjusted to be neutral, about 6.5-7.5. Implementing these solvent parameters for use in the thermochromic system will preserve the reversible coloration ability of the leuco dyes.

Formulations for thermochromic systems are engineered with all the considerations previously mentioned. The examples below describe a thermochromic system with excellent color density, low residual color, narrow temperature ranges between full color and clearing point, and a narrow hysteresis window. The full color point and the clearing point are determined by visual inspection of the thermochromic system at a range of temperatures. The difference in temperature between the maxima of color change during the cooling cycle and the heating cycle is used to calculate hysteresis.

### Adjusting the Acid Content

Water-base inks are pH adjusted prior to addition of thermochromic pigment. As mentioned above, the pH should be neutral unless observation indicates that a different pH is required. To achieve the correct pH, one uses a good proton donor or acceptor, depending on whether the pH is to be adjusted up or down. To lower the pH, HCl is used, to raise it, the best proton acceptor so far is KOH. These two chemicals are very effective and do not seem to impart undesirable characteristics to the medium. (In other words, K+ and Cl— do not seem to harm the thermochromic pigment.) Use pH paper to determine the pH. Remember not to add pigment before the pH and all other characteristics for that matter are correct in the ink itself. The most effective pH has been 7.0, however, some tolerance has been noted between 6.0 and 8.0. A pH below 6.0 and above 8.0 frequently destroys the pigment.

The acid value is defined as the number of milligrams of a 0.1 N KOH solution required to neutralize the alkali reactive groups in 1 gram of material under the conditions of ASTM Test Method D-1639-70. It is not yet fully understood how non-aqueous substances containing acid affect the thermochromic, but high acid number substances have inactivated the thermochromic pigments. Generally, the lower the acid number the better. To date ink formulations with an acid value below 20 and not including the harmful solvents described above have worked well. Some higher acid value formulations may be possible but generally it is best to use vehicle ingredients with low acid numbers or to adjust the acid value by adding an alkali substance. The greatest benefit of a neutral or low acid value vehicle will be increased shelf life.

Buffers have been used historically in offset ink formulations to minimize the effects of the fountain solution on pigment particles. This is one possible solution to the potential acidity problem of the varnishes. One ingredient often used as a buffer is cream of tartar. A dispersion of cream of tartar and linseed oil can be incorporated into the ink. The net effect is that the pigments in the ink are protected from the acidic fountain solution. Alternatively, the salt of a weak acid may be used as a buffer.

### Mixing

Thermochromic leuco dyes formulated as inks are sold as a dry powder or a water based slurry. Mixing systems have been developed for both slurry and powder that will allow for consistent and well dispersed pigment.

### Drying Technique

The aqueous slurry may be used to make solvent based ink formulations by drying the slurry first. In traditional ink manufacturing, there is a technique known as flushing. Many traditional pigments come in slurry form, similar to that of the thermochromic capsules. “Flushing” in traditional manufacturing, means to press most of the water out of the slurry to form what is called a press cake which is then “flushed” into a mixing varnish. The press cake is about 25-40% solids. Because of the hydrophobic properties of the pigment and the varnish, the pigment is mixed into the varnish and away from the water. The water separates from the varnish and is left behind. Flushing with the thermochromic capsules does not work. All of the water stays in the varnish rather than separating. This may happen because of the water's attraction to the surface of the capsule.

### Ink Formulations

The encapsulated thermochromic systems of the present disclosure may be referred to as pigments. In an embodiment of the present disclosure, the pigments are used in formulating thermochromic dyes. In order to add normal pigment to ink, dye, or lacquer, the pigment itself is ground into the base. This disperses the pigment throughout the base. Since the pigment is usually a solid crystal with a diameter no larger than 1.0 microns this grinding is not difficult to do. The eye cannot see particles that size, so the pigment will give the base a solid color. The addition of more pigment intensifies the color. Since the pigment has a very intense color only about 10% of the final ink is made up of normal pigments.

A base for an ink formulation using encapsulated thermochromic systems of the present disclosure may be developed using off the shelf ingredients. The ink will incorporate, where possible, and be compatible with different ink types and solvents with molecular weights larger than 100 while avoiding aldehydes, diols, ketones, and, in general, aromatic compounds. Important considerations with respect to the ingredients within the ink vehicle are the reactivity of the ingredients with the encapsulated thermochromic system.

An example of unwanted interactions between media and the encapsulated thermochromic systems can occur between compounds found in ink formulations. The long alkyl chains of many of the compounds found in ink vehicles may have reactive portions that can fit through the pores of the capsule and interact with the inner phase and denature it through this interaction. Since the behavior of the thermochromic system is related to the shape and the location of its molecules at given temperatures, disrupting these structures could have a large impact on the characteristics of the thermochromic system. Even molecules that cannot fit through the capsule pores may have reactive portions that could protrude into the capsule and thereby influence the color transition of the thermochromic system within the capsule. Therefore, mineral spirits, ketones, diols, and aldehydes are preferably minimized in any medium in which the encapsulated are also preferably avoided. If these compounds are substantially reduced or eliminated the thermochromic systems will perform better and have a longer shelf life.

Another important step in using the encapsulated thermochromic systems of the present disclosure in ink formulations is to adjust the pH or lower the acid value of the ink base before the thermochromic system is added. This can be done by ensuring that each individual component of the base is at the correct pH or acid value or by simply adding a proton donor or proton acceptor to the base itself prior to adding the thermochromic system. The appropriate specific pH is generally neutral, or 7.0. The pH will vary between 6.0 and 8.0 depending on the ink type and the color and batch of the thermochromic system.

Once a slurry and the base have been properly prepared, they are combined. The method of stirring should be low speed with non-metal stir blades and other manufacturing equipment known to those skilled in the art of ink making. Other additives may be incorporated to keep the thermochromic system suspended. The ink should be stored at room temperature.

Most thermochromic inks undergo a color change from a specific color to colorless. Therefore, layers of background colors can be provided under thermochromic layers that will only be seen when the thermochromic layer changes to colorless. If an undercoat of yellow is applied to the substrate and then a layer containing blue thermochromic dye is applied the color will appear to change from green to yellow, when what is really happening is that the blue is changing to colorless.

In an embodiment of the present disclosure an encapsulated thermochromic system may be formulated as an ink by placing the slurry in a forced air dryer where the temperature is maintained at between 100 and 150 degrees ° F. When the slurry reaches the “stiff clay” stage, at about 80% to 95% solids, the slurry is removed and incorporated into a varnish. The varnish is mixed until smooth and the remaining ingredients are than added to this mixture. This mixture is then run over the mill, making the final product. A press cake which has 80 to 95 percent solids does not alter the properties of the ink too severely.

If the ink requires powder to make it, there may be a problem with dispersion because, in the drying process, the capsules form aggregates that are very difficult to break up. Over stirring or the wrong type of stirring will damage or denature the dye. The technique that has been developed to solve this problem is simple, effective and inexpensive. The first step is to add the powder to an appropriate solvent as listed above. The solids content of this mixture should be about the same as for the water base slurry of about 50% solids. Once the solvent and the powder are combined, the container with the mixture is submerged in an ultrasound bath. The vibration breaks up the aggregates and also conditions the capsule for its addition to the rest of the formulation medium.

The substrates that the thermochromic inks are printed upon should be neutral in pH, and should not impart any chemicals to the capsule that will have a deleterious effect on it.

An example of a specific formulation of thermochromic systems are provided below using the principles and techniques taught above.

An aqueous slurry of thermochromic pigment containing approximately 50% pigment solids is dried in an oven at 100-150° F. to achieve a solids concentration of 80%-95% by weight of thermochromic system. Solid levels below 80% introduce excess water into finished ink formulations and make it difficult to properly disperse the thermochromic system in the ink vehicle, and generally solids concentrations above 90% are preferable. Solids greater than 95% result in strong agglomeration of the thermochromic system particles and make dispersion difficult, however, drying to solids concentrations up to 98% has worked. The consistency of the dried thermochromic system slurry will vary between that of wet clay and nearly dry kernels and flakes. This material is then combined with a grinding/mixing varnish formulated for the dispersion of dry thermochromic system or press cake, which typically is high in tack and viscosity, may contain a significant proportion of alkyd resin, and have an acid value not to exceed 15.

In an embodiment, thermochromic systems of the present disclosure formulated as dyes or inks may be used for the printing of identification or forgery detection marks or patterns on security documents. These inks may also be used simultaneously with conventional printing inks and also may be used with pre-existing printers by substitution with one of the normally used printing inks.

The various embodiments shown below are nonlimiting in nature, teaching by way of example and not by limitation.

### Example 1

A microencapsulated thermochromic system that is unimproved with methods of formulation from the present disclosure has the following composition and thermochromic characteristics:

| | | | Temp. |
|---|---|---|---|
| IP Solvent | Dye(s) | Developer | Modifier |
| Methyl | Black XV | BPA | None |
| Palmitate | GN-2 | | |
| 82% | 7% | 11% | — |

### Full Color Point: 12° C.

### Clearing Point: 26° C.

### Hysteresis Window: 10.1° C.

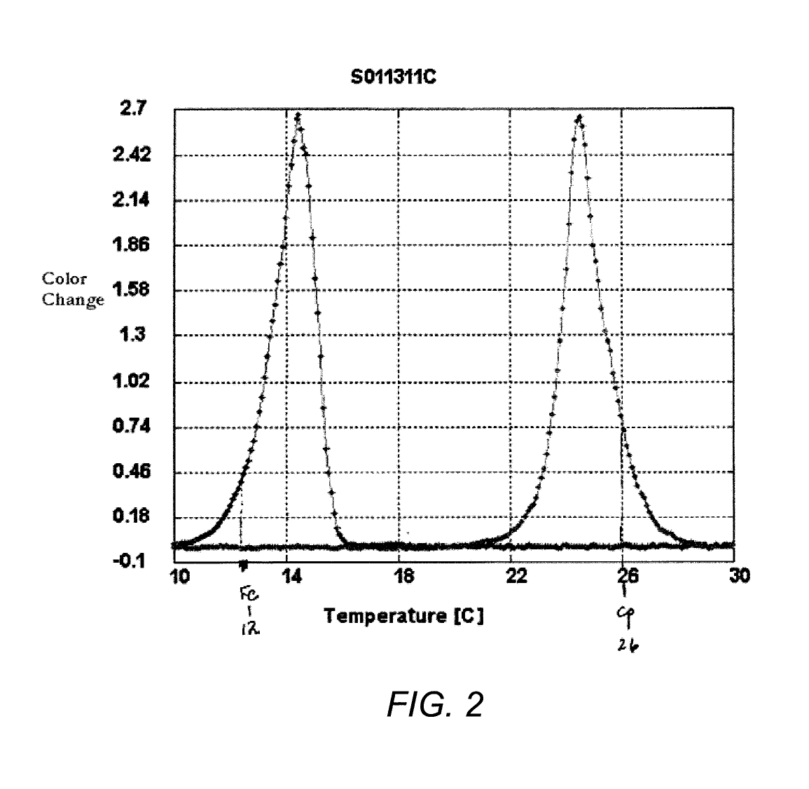

FIG. 2 depicts the wide (˜10° C.) hysteresis window of the microencapsulated thermochromic system of example 1 and the broad color transition range of ˜14° C.

The thermochromic systems of the present disclosure improve upon existing thermochromic systems by narrowing the temperature transition range and by decreasing the hysteresis window. The hysteresis window is narrowed at both the full color point and the clearing point to less than 5° C. and preferably to less than 1° C.

A thermochromic dye system having an improved hysteresis window and a narrower color transition range between the full color point and the clearing point can be made by adding a co-solvent into a known thermochromic system. The co-solvent can be added in amounts varying from about 12% to about 15% of the weight of the thermochromic system, excluding the capsule. The solvent can be chosen from the following list of solvents including singly or in combination: isopropyl myristate, isopropyl palmitate, methyl palmitate, methyl stearate, myristyl, myristate, cetyl alcohol, stearyl alcohol, behenyl alcohol, stearyl behenate, and stearamide. In another embodiment of the present disclosure, a more preferred co-solvent list consists of stearamide, behenyl alcohol and stearyl behenate from about 12% to about 15% by weight.

The co-solvent should also have the attribute of having a long alkyl chain, preferably between 12 and 24 carbons as well as having a melting point that is about 70° C. to about 200° C. above the other co-solvent of the thermochromic system. Example 2 shows a preferred embodiment of the present disclosure using behenyl alcohol as both a temperature modifier and co-solvent. The co-solvent system has an improved hysteresis window and a narrower color transition range between the full color point and the clearing point over Example 1, a pre-existing thermochromic system.

### Example 2

A microencapsulated thermochromic system that is improved with methods of and formulations from the present disclosure has the following composition and thermochromic characteristics:

| | | | Temp. |
|---|---|---|---|
| IP Solvent | Dye(s) | Developer(s) | Modifier |
| Methyl | Black XV, | BPA | Behenyl |
| Palmitate | GN-2 | | alcohol |
| 69.7% | 7% | 11% | 12.3% |

### Full Color Point: 16° C.

### Clearing Point: 23.5° C.

### Hysteresis Window: 3.6° C.

FIG. 3 shows that the hysteresis window of the microencapsulated thermochromic system of example 2 has been narrowed by increasing the full color point 4° C. and decreasing the clearing point 2.5° C. so that the color transition range is ˜7° C. The hysteresis window is now less than 5° C.

Accordingly, it is to be understood that the embodiments of the disclosure herein described are merely illustrative of the application of the principles of the disclosure. Reference herein to details of the illustrated embodiments is not intended to limit the scope of the claims, which themselves recite those features regarded as essential to the disclosure.

1. In a reversible or semi-reversible thermochromic ink or coating that contains microcapsules encapsulating a thermochromic system mixed with a solvent, the thermochromic system having a material property of a thermally conditional hysteresis window presenting a thermal separation, the improvement comprising:
a co-solvent that is combined with the thermochromic system and selected from the group consisting of derivatives of mysristic acid, derivatives of behenyl acid, derivatives of palmytic acid and combinations thereof;
the material being provided in an effective amount to reduce the thermal separation in the overall ink to a level less than eighty percent of separation that would otherwise occur if the material were not added.

2. The ink of claim 1, wherein the separation is less than 5° C.

3. The ink of claim 1, wherein the effective amount ranges from 12% to 15%.

4. The composition of claim 1 wherein the co-solvent is selected from the group consisting of: isopropyl myristate, isopropyl palmitate, methyl palmitate, methyl stearate, myristyl, myristate, cetyl alcohol, stearyl alcohol, behenyl alcohol, stearyl behenate, and stearamide.

5. The ink of claim 1, wherein the thermochromic system includes at least one chromatic organic compound selected from the group consisting of diphenylmethane phthalide derivatives, phenylindolylphthalide derivatives, indolylphthalide derivatives, diphenylmethane azaphthalide derivatives, phenylindolylazaphthalide derivatives, fluoran derivatives, 2,4,6-trisubstituted pyridines, quinazolines, bisquinazolines styrynoquinoline derivatives, and diaza-rhodamine lactone derivatives.

6. The ink of claim 1, further including a light stabilizer.

7. The ink of claim 6, wherein the thermochromic system includes at least one chromatic organic compound selected from the group consisting of diphenylmethane phthalide derivatives, phenylindolylphthalide derivatives, indolylphthalide derivatives, diphenylmethane azaphthalide derivatives, phenylindolylazaphthalide derivatives, fluoran derivatives, styrynoquinoline derivatives, and diaza-rhodamine lactone derivatives.
